(19) United States
(12) Patent Application Publication
(10) Pub. No.: US 2013/0142518 A1
(43) Pub. Date: Jun. 6, 2013

(54) OPTICAL TRANSMISSION MODULE

(71) Applicant: YI-ZHONG SHEU, Tu-Cheng (TW)

(72) Inventor: YI-ZHONG SHEU, Tu-Cheng (TW)

(73) Assignee: HON HAI PRECISION INDUSTRY CO., LTD., Tu-Cheng (TW)

(21) Appl. No.: 13/403,166

(22) Filed: Feb. 23, 2012

(30) Foreign Application Priority Data
Dec. 1, 2011 (TW) 100144179

(51) Int. Cl. H04B 10/10

(52) U.S. Cl. 398/130

(57) ABSTRACT

An optical transmission module includes an optical transmitting unit and an optical receiving unit. The optical transmitting unit includes a first laser diode and a second laser diode. The optical receiving unit includes a first photo diode and a second photo diode, in which the second photo diode is electrically connected to the first photo diode. The second photo diode converts the light energy of the light transmitted by the second laser diode into electrical energy to drive the first photo diode so as to convert the optical signal transmitted by the first laser diode into an electrical signal.

### BACKGROUND

1. Technical Field

The present disclosure relates to optical transmission modules, particularly to an optical transmission module for data transmission.

2. Description of Related Art

An optical transmission module generally includes an optical transmitting unit and an optical receiving unit. The optical transmitting unit includes a laser diode. The optical receiving unit includes a photo diode to change the optical signals transmitted by the laser diode of the optical transmitting unit into electrical signals. When the photo diode is operating, it needs to be driven by an additional electrical power source. As a result, the photo diode is usually connected to an additional electrical power source, and thus it is not convenient to use the optical transmission module.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the optical transmission module. Moreover, in the drawings like reference numerals designate corresponding parts throughout the several views. Wherever possible, the same reference numerals are used throughout the drawings to refer to the same or like elements of an embodiment.

FIG. 1 is a perspective view of a first embodiment of an optical transmission module.

FIG. 1 is a perspective view of a second embodiment of an optical transmission module.

### DETAILED DESCRIPTION

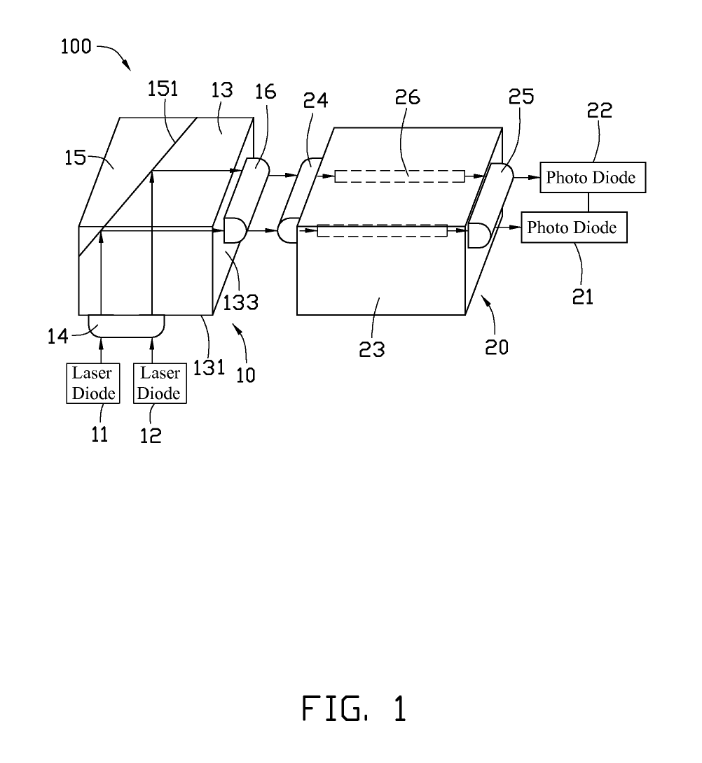

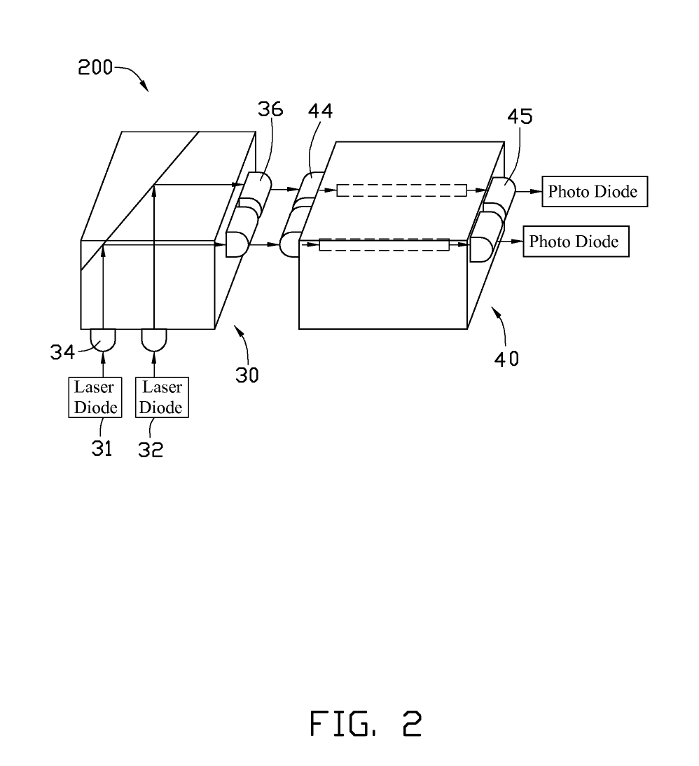

Referring to FIG. 1, an embodiment of an optical transmission module 100 comprises an optical transmitting unit 10 and an optical receiving unit 20. The optical transmitting unit 10 comprises a first laser diode 11, a second laser diode 12, a transparent base board 13, a first convex lens 14, a second convex lens 16, and a reflector 15. In the illustrated embodiment, the transparent base board 13 is a transparent block with a corner cut off. The transparent base board 13 is made of transparent organic glass. The transparent base board 13 is used as a transmission medium to transmit two parallel beams of light transmitted by the first and second laser diodes 11, 12 and to fix the convex lenses 14, 16 and the reflector 15.

In the illustrated embodiment, the reflector 15 is fixed on the corner of the transparent base board 13. The reflector 15 and the transparent base board 13 cooperatively form a substantially rectangular block. The transparent base board 13 comprises a bottom surface 131 adjacent to the laser diodes 11, 12 and a side surface 133 away from the reflector 15. The first convex lens 14 is fixed on the bottom surface 131 of the transparent base board 13, and the second convex lens 16 is fixed on the side surface 133 of the transparent base board 13. The convex lenses 14, 16 are used to transmit and converge the light transmitted by the laser diodes 11, 12. The reflector 15 comprises a reflected surface 151. The two parallel beams of light emitted by the laser diodes 11, 12 are perpendicularly irradiated on the first convex lens 14. And then, the two parallel beams of light are reflected by the reflector 15 and perpendicularly irradiated on the second convex lens 16. Later, the two parallel beams of light are then transmitted to the optical receiving unit 20.

In alternative embodiments, the transparent base board 13 may be substantially circular or rectangular, and the convex lenses 14, 16 may be inserted into the transparent base board 13.

The optical receiving unit 20 comprises a first photo diode 21, a second photo diode 22, a transparent base board 23, a third convex lens 24, and a fourth convex lens 25. In the illustrated embodiment, the transparent base board 23 is made of transparent organic glass, and is in the form of a transparent rectangular block. The convex lenses 24, 25 are fixed on two opposite ends of the transparent base board 23 to transmit and converge the two parallel beams of light transmitted by the laser diodes 11, 12. In the illustrated embodiment, the convex lenses 16, 24, 25 are parallel to one other and arranged in a line to make sure that the two parallel beams of light can be converged by the convex lenses 16, 24, 25 in order.

The optical signal transmitted by the first laser diode 11 is irradiated on the first photo diode 21 after the converging of the beam of light transmitted through the convex lenses 14, 16, 24, respectively, and the reflecting of the corresponding beam of light by the reflector 15. The light transmitted by the second laser diode 12 is irradiated on the second photo diode 22 after the converging of the beam of light transmitted through the convex lenses 14, 16, 24, respectively, and the reflecting of the corresponding beam of light by the reflector 15. In the illustrated embodiment, the first photo diode 21 is electrically connected to the second photo diode 22. The second photo diode 22 converts the light energy of the light transmitted by the second laser diode 12 into electrical energy to drive the first photo diode 21 to convert the optical signal transmitted by the first laser diode 11 into an electrical signal.

The optical receiving unit 20 further comprises two optical fibers 26 respectively connecting the third convex lens 24 with the fourth convex lens 25. The optical transmission of the optical fiber 26 is more effective than that of air or transparent organic glass.

In alternative embodiments, any one of the convex lenses 14, 16, 24, 25 can be omitted.

Referring to FIG. 2, an alternative embodiment of an optical transmission module 200 comprises an optical transmitting unit 30 and an optical receiving unit 40. The optical transmitting unit 30 is similar to the optical transmitting unit 10 found in the previous embodiment, except that the optical transmitting unit 30 comprises two first convex lenses 34 and two second convex lenses 36. One first convex lens 34 and one second convex lens 36 are used to converge a beam of light transmitted by a first laser diode 31, and the other first convex lens 34 and the other second convex lens 36 are used to converge a beam of light transmitted by a second laser diode 32. It is convenient to install the laser diodes 31, 32.

The optical receiving unit 40 is similar to the optical receiving unit 20 found in the previous embodiment, except that the optical receiving unit 40 comprises two third convex lenses 44 and two fourth convex lenses 45. One third convex lens 44 and one fourth convex lens 45 are used to converge the beam of light transmitted by the first laser diode 31, and the other third convex lens 44 and the other fourth convex lens 45 are used to converge the beam of light transmitted by the second laser diode 32.

In alternative embodiments, any of the convex lenses 34, 36, 44, 45 can be omitted.

In summary, the second photo diode 22 converts the light energy of the light transmitted by the second laser diode 12 into electrical energy to drive the first photo diode 21 to converts the optical signal transmitted by the first laser diode 11 into an electrical signal. It is convenient to use as well as providing benefit from omitting requiring additional electrical power.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An optical transmission module, comprising:
an optical transmitting unit comprising a first laser diode and a second laser diode;
an optical receiving unit comprising a first photo diode and a second photo diode, the second photo diode is electrically connected to the first photo diode, wherein the second photo diode converts the energy of the light transmitted by the second laser diode into electrical energy to drive the first photo diode to convert the optical signal transmitted by the first laser diode into an electrical signal.

2. The optical transmission module of claim 1, wherein the optical transmitting unit further comprises a transparent base board and a reflector, the transparent base board is a transparent block with a corner cut off, and the reflector is fixed on the corner of the transparent base board.

3. The optical transmission module of claim 2, wherein the transparent base board is made of transparent organic glass.

4. The optical transmission module of claim 2, wherein the reflector comprises a reflected surface used to reflect two parallel beams of light transmitted by the first and second laser diodes, respectively.

5. The optical transmission module of claim 4, wherein the optical transmitting unit further comprises a first convex lens fixed on a bottom surface of the transparent base board and a second convex lens fixed on a side surface of the transparent base board away from the reflector.

6. The optical transmission module of claim 5, wherein the optical receiving unit further comprises a transparent base board, a third convex lens and a fourth convex lens, and the third convex lens and the fourth convex lens are fixed on two opposite ends of the transparent base board.

7. The optical transmission module of claim 6, wherein the optical receiving unit further comprises two optical fibers connecting the third convex lens with the fourth convex lens, respectively.

8. The optical transmission module of claim 7, wherein the second, the third, and the fourth convex lenses are parallel to each other, and arranged in a line.

9. The optical transmission module of claim 8, wherein the number of the first, the second, the third, and the fourth convex lenses is two, respectively.
